(19) United States
(12) Patent Application Publication
(10) Pub. No.: US 2010/0247828 A1
(43) Pub. Date: Sep. 30, 2010

(54) Strengthened Tubular Fabric and Corresponding Fabrication Method

(76) Inventor: Ji Ye Wang, Guangdong (CN)

Correspondence Address: WANG & HO, 66 HILLTOP ROAD, MILLINGTON, NJ, 07946, US

(21) Appl. No.: 12/413,594

(22) Filed: Mar. 29, 2009

(51) Int. Cl. B32B 1/08

(52) U.S. Cl. 428/36.1

(57) ABSTRACT

The present invention discloses a tubular fabric with strengthened fabric structure, formed from interlaced warp yarns and weft yarns where at least one of the warp yarns is spandex yarn. The tubular fabric is characterized in that the spandex yarn accounts for 6%-12% of the total fabric weight, the spandex yarn has a floating line on the inner wall surface not shorter than 3 weft yarns, and the weft density is between 14-30% weft/cm. Due the special weaving structure, which results in the long floating line of the spandex yarn, the resulting tubular fabric have a large amount of spandex yarns covering its inner wall surface, thereby enhancing its strength and effectively prevent perforation by the steel wire.

### TECHNICAL FIELD

The present invention relate to a subject matter in the textile field. More particularly, it relates to narrow woven tubular fabrics.

### TECHNICAL BACKGROUND OF THE INVENTION

Some underwear, such as bras, usually uses a fabric covering for any shape-keeping steel wire, which generally is a tubular fabric. At present, two types of such tubular fabrics for covering steel wires are available in the market: those that contain hot-melt yarn and those that do not have any hot-melt yarn. The tubular fabrics without hot-melt element are structurally loose and prone to perforation. The tubular fabrics with hot melt yarns in the weft, which during the drying process are hot-melt and adhered to the cross-points of other yarns within the fabric, have an enhanced strength to effectively prevent the steel wire from perforating. For example, U.S. Pat. No. 6,071,578 to Roy Richardson, etc, discloses a tubular fabric with a hot-melt yarn, which is hot-melt to form a barrier on the inner wall of the tubular fabric to prevent perforation by the steel wire.

### SUMMARY OF THE INVENTION

The present invention deals with the perforation problems existed in tubular fabrics without using hot-melt elements and provides a tubular fabric (or “wire casing”) containing spandex. The tubular fabric contains no hot-melt element but has overcome the perforation problem by using an improved fabrication design. The resulting tubular fabrics can even have a greater strength than the tubular fabric using the hot-melt yarn, thereby effectively solved the perforation problem for non hot-melt wire casings.

The present invention is accomplished in a way detailed in the following:

The present invention provides a tubular fabric, comprising a number of interlaced warps and wefts. At least one of the warp yarns is a spandex yarn and its floating line length on the inner surface of the wire casing is at least 3 wefts.

The structure of the spandex yarn within the tubular fabric is preferably of a configuration that is three intermediate and one low and three intermediate and one high. Of course, a person skilled in the art can choose other structures so long that the chosen structure can lead to spandex covering a necessarily large area of the inner wall surface of the tubular fabric.

Preferably, the spandex yarn accounts at least 6% by weight, and weft density is at least 14 weft/cm.

The content of the spandex yarn is preferably within the range from 6% to 12% by weight, and the weft density is within the range from 14 to 30 weft/cm.

More preferably, the spandex yarn accounts for 8% of the total weight, and weft density of 15.7 weft/cm.

The warp threads include at least two yarns. One is a spandex yarn and the other yarns can be nylon or other suitable materials.

The tubular fabrics according to the present invention eliminates the need for any hot-melt materials or any materials similar to hot-melt materials.

Tubular fabric as described above have a special organizational structure, not existing in the prior art, which causes longer spandex warp floating lines and thus covers the inner wall surface with much more spandex, which is found to be able to enhance the strength of the tubular fabric. For perforation to occur, the steel wire has to first penetrate the inner wall. Therefore, properly increasing the amount of spandex on the inner wall can increase the tubular fabric's strength and thus effectively prevent perforation. The tubular fabric of the present invention is applicable to any clothing articles, particularly to undergarments, such as bra, women's lingerie, swimsuit, and so on.

### BRIEF DESCRIPTION OF THE DRAWINGS

FIG. 1 is a diagram showing a cross sectional view of a tubular fabric of the prior art.

FIG. 2 is a diagram showing the inner wall surface of the tubular fabric in FIG. 1

FIG. 3 is a fabric diagram showing the organizational structure of spandex within the tubular fabric in FIG. 1.

FIG. 4 is a cross-sectional view of the tubular fabric as an embodiment of the present invention.

FIG. 5 is a diagram showing the inner wall surface of the tubular fabric in FIG. 4.

FIG. 6 is a fabric structural diagram showing the organizational structure of spandex within the tubular fabric in FIG. 4.

FIG. 7 is a diagram showing the warp yarn arrangement in the tubular fabric in FIG. 4.

FIG. 8 is a diagram showing the warp yarn structural chart of the tubular fabric in FIG. 4.

FIG. 9 is a diagram showing the vertical fabric diagram of the tubular fabric in FIG. 4.

### DETAILED DESCRIPTION OF SPECIFIC EMBODIMENTS OF THE INVENTION

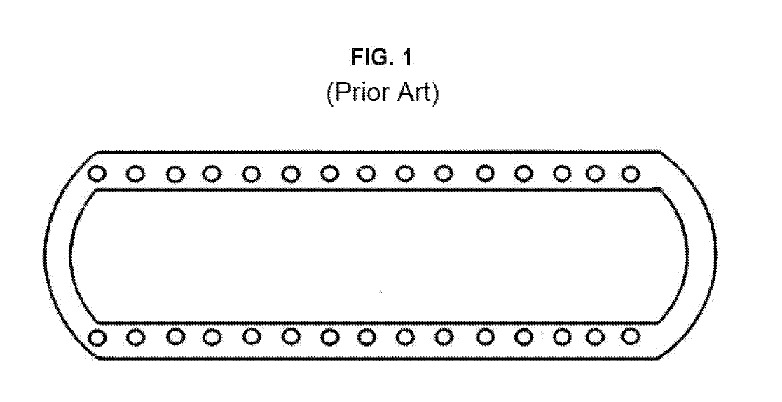

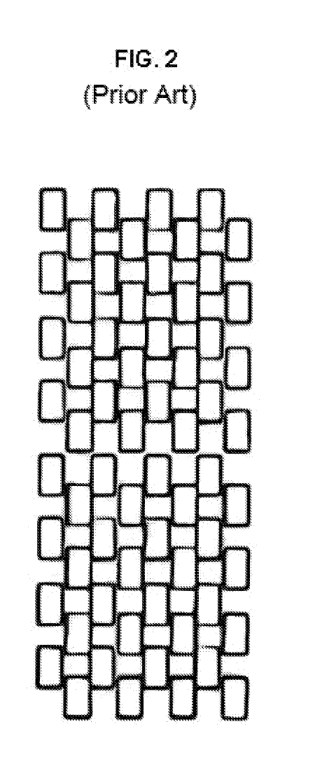

Spandex in the fabric, due to its excellent elasticity, good shape-recovery performance, plays a beneficial role of retraction in the fabric, thereby enhancing the strength of the fabric against perforation. Shown in FIG. 1 to FIG. 3 is the structural diagram of conventional type wire casing. As it is shown in the chart, spandex is located in the intermediate layer of the fabric with short floating-point.

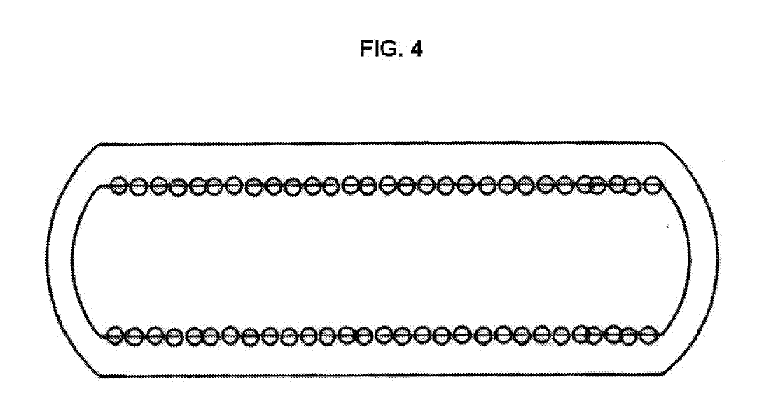

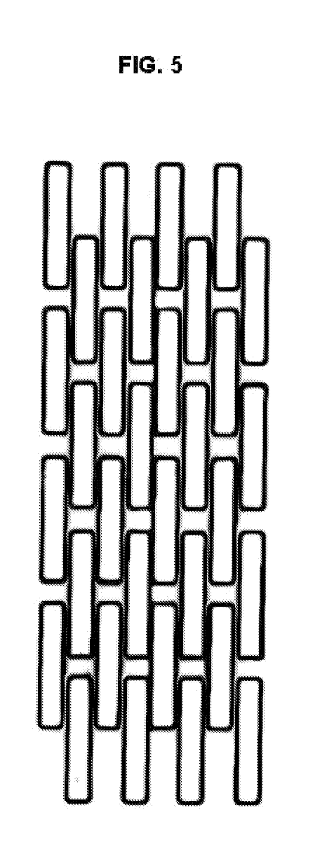

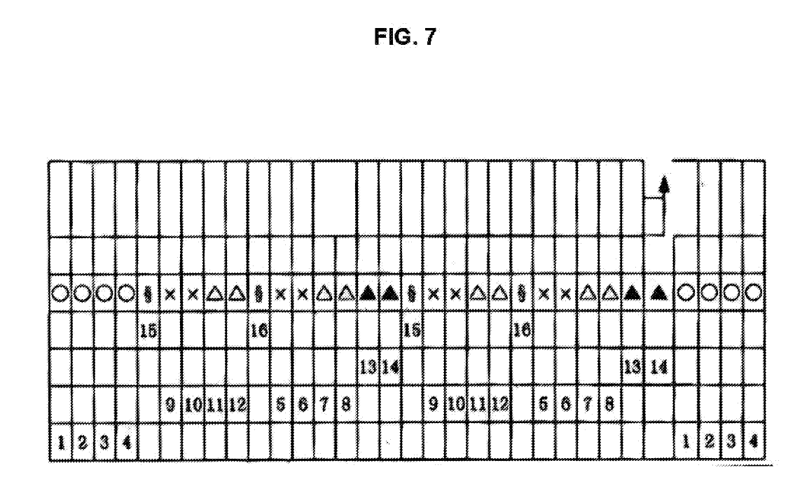

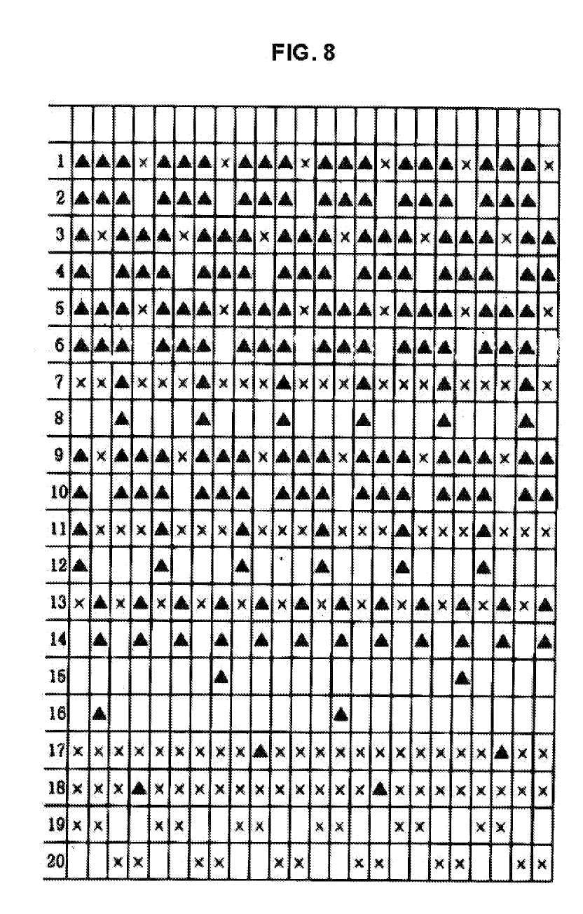

FIG. 4 to FIG. 6 show that a tubular fabric as a particular embodiment of the present invention. The tubular fabric 1 (also referred to as “wire casing”) comprising sheet structures. The two sheet structures are sewed together to form a hollow tubular fabric. Each sheet structure is formed by weaving one weft yarn with a number of warp yarns. Based on testing, it is noted that the inner wall surface was covered with a large amount of spandex yarns, which effectively enhanced the fabric's strength against penetration. The tubular fabric according to the present invention contains at least one spandex yarn in the warp threads and the resulting tubular fabric has spandex yarn covering its inner wall surface wherein the spandex has a long floating line, covering at least 3 weft threads. This fabric structure can be achieved by using the warp arrangement shown in FIG. 7 and the warp organization shown in FIG. 8.

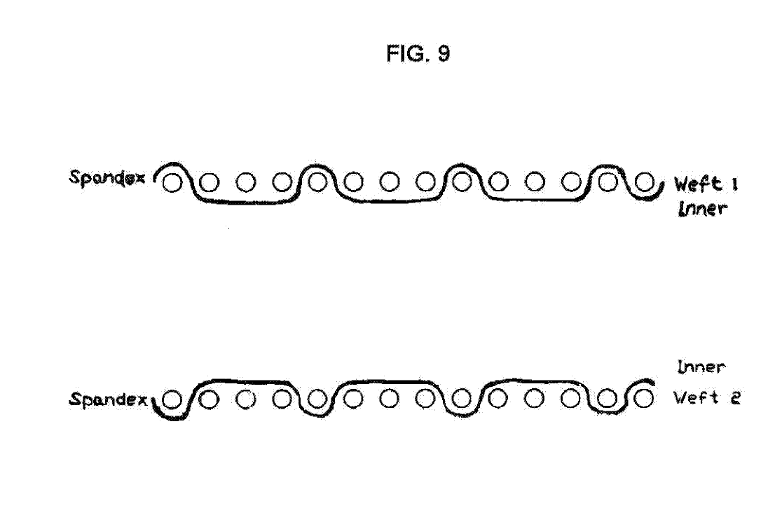

Now turning to FIG. 9, the curve represents the spandex yarn, the circle represents the weft, and only the directions of the spandex yarn and the weft yarn in the upper and lower layering structures are shown in the drawing. In this particular embodiment, the floating line of the spandex yarn on the inner wall surface covering three weft yarns separated by a weft yarn, in a fabric structure of three intermediate with one low and three intermediate with one high. Of course, other similar structure arrangements may also be used as long as they result in necessary long floating line for the spandex warp yarn.

The following is a comparison of the fabric strength against penetration between tubular fabrics made according to conventional method and the present invention, respectively.

| | | | weft | | Meet the Martha |
|---|---|---|---|---|---|
| | | spandex | density | the average | Standard |
| samples | hot-melt | (%) | (weft/cm) | strength (Kg) | (25.0 Kg) |
| A | YES | 3.6% | 11.7 | 20.0 | No |
| B | NO | 8.0% | 15.7 | 29.0 | Yes |

Note:
Sample A containing hot-melt steel wire fabric and sample B is the fabric of the present invention containing no hot-melt yarns.

In the above described embodiment, the spandex yarn accounted for 8% of the total fabric weight and weft density is 15.7 weft/cm, which gave the better result as shown above. According to the test results, to achieve the purpose of this invention, that is, effective prevention of steel wire penetration, the spandex fabric content and weft density should be as follows: the spandex yarn is greater than 6% by weight and the weft density is at least 14 weft/cm-30 wet/cm. Preferably, the spandex's content should be between 6%-12% and weft density should be between 14 weft/cm to 30 weft/cm.

As it can be seen from the above table, in sample A, the spandex in the middle and account for only 3.6%, and the weft density is 11.7 weft/cm, resulting an average strength requirement of less than the Martha requirement, which is 25.0 Kg.

For sample B, the spandex yarn is on the inner wall surface, with an increased content of 8% by weight, which improves the strength significantly. The present invention is suitable for machine weaving processes. By setting a high weft density on the machine, hard hand feel increases and a the same time the strength against penetration enhances, making penetration more difficult. From the above table, it can be seen when the weft density increases from 11.7 weft/cm to 15.7 weft/cm, the fabric strength increases, exceeding the Martha requirement (25 Kg).

The tubular fabrics available at the moment in the market are all with a two-layered structure, where the spandex yarn is set as: one-middle with one above and one-middle with one below. This is a common structure which can only place the spandex in the middle of the fabric. In contrast, the present invention, thinking outside the box, arranges the spandex yarn's course as: three-middle with one above and three-middle with one below. This three-middle with one above and three-middle with one below setting, to largest extent, places the spandex yarn on the inner wall surface, and effectively increase the strength of the resulting tubular fabric against penetration by the steel wire. Based on the testing results by outside testing organization, the tubular fabric's strength against penetration satisfies the Martha requirement.

The above tubular fabric of the present invention was made preferably by a narrow loon weaving machine manufactured by Muller of Swiss (model number: NF 6/27). The spandex yarn was preferably from Japanese Asahi Kasei (specifications: 420D, 40 spandex yarn). Of course, people skilled in the art may choose other suitable machines and spandex yarns to practice the present invention.

The foregoing description is for merely explaining and illustrating the tubular fabric made according to the present invention. The manner to practice the present invention includes, but is not limited to, the above described example. It should be understood that various modifications and changes can be made without departing from the spirit of the present invention.

For FIG. 7, the meaning of the symbols is as follows:

▴=nylon yarn (Model 1)

§=nylon yarn (model 2)

Δ=nylon yarn (model 3)

×=nylon yarn (model 4)

◯=spandex yarn

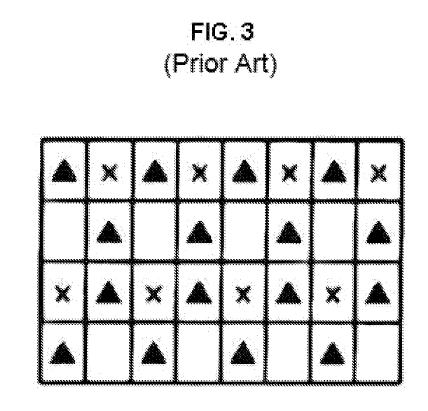

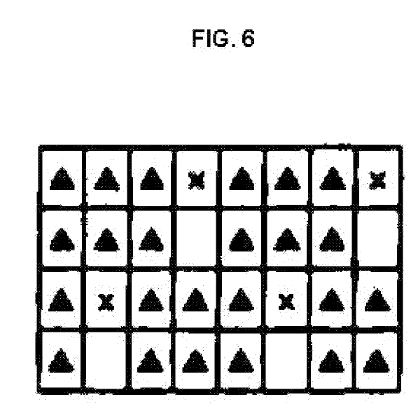

For FIG. 3, FIG. 6 and FIG. 8, the meaning of the symbols is as follows:

▴=intermediate chain

×=high chain

□=low chain

What is claimed is:

1. A strengthened tubular fabric, comprising a plurality of interlaced warp yarns and weft yarns, said warp yarns comprises at least one spandex yarn, characterized in that the floating line of said spandex yarn on the inner wall surface of the tubular fabric is not short than 3 weft yarn.

2. The tubular fabric of claim 1, characterized in that within the tubular fabric said spandex yarn has an organization structure of three middle with one below and three middle with one above.

3. The tubular fabric of claim 1, characterized in that said spandex yarn accounts for at least 6% by weight of the tubular fabric and the weft density is at least 14 weft/cm.

4. The tubular fabric of claim 1, characterized in that said spandex yarn accounts for 6%-12% by weight of the tubular fabric and the weft density is 14-30 weft/cm.

5. The tubular fabric of claim 1, characterized in that said spandex yarn accounts for at least 8% by weight of the tubular fabric and the weft density is at least 15.7 weft/cm.

6. The tubular fabric of claim 1, characterized in that said wrap yarns are of two types, one type being spandex yarn.

7. The tubular fabric of claim 1, characterized in that said warp yarns and weft yarns are fee of any hot-melt yarns.
